(19) United States
(12) Patent Application Publication
(10) Pub. No.: US 2024/0215552 A1
(43) Pub. Date: Jul. 4, 2024

(54) CO-HABITATION OF AQUATIC SPECIES AND ALGAE

(71) Applicant: SIGNIFY HOLDING B.V., EINDHOVEN (NL)

(72) Inventors: MARC ANDRE DE SAMBER, LOMMEL (BE); MARCELLINUS PETRUS CAROLUS MICHAEL KRIJN, EINDHOVEN (NL); MAURICE ALEXANDER HUGO DONNERS, WAALRE (NL)

(21) Appl. No.: 18/558,430

(22) PCT Filed: Apr. 21, 2022
(86) PCT No.: PCT/EP2022/060594

§ 371 Date: Nov. 1, 2023

(30) Foreign Application Priority Data
May 6, 2021 (EP) 21172381.2

(51) Int. Cl. A01K 61/59; A01G 33/00; A01K 63/00; A01K 63/06

(52) U.S. Cl. CPC A01K 61/59; A01G 33/00; A01K 63/003; A01K 63/06

(57) ABSTRACT

The invention provides a method for growing arthropods and photo-autotrophic organism in a shared water recipient (2000), wherein the method comprises: (a) monitoring an arthropod monitoring parameter of the arthropods in the shared water recipient, wherein the arthropod monitoring parameter is related to one or more of growth, metabolism, and behavior of the arthropods: and (b) controlling an photo-autotrophic organism control parameter of the photo-autotrophic organism in the shared water recipient in dependence of the arthropod monitoring parameter, wherein the photo-autotrophic organism control parameter influences one or more of growth and metabolism of the photo-autotrophic organisms.

### FIELD OF THE INVENTION

The invention relates to a method for arthropod growing. The invention also relates to an arthropod growing system. The invention further relates to a computer program product that can be used to execute such method (with such system).

### BACKGROUND OF THE INVENTION

Systems for shrimp keeping are known in the art. US2015/0237890, for instance, describes a system for enhancing the growth of aquatic life comprising: a first raceway extending from an inlet to an outlet with a channel therebetween holding water; a second raceway in fluid communication with the first raceway extending from a second inlet to a second outlet with a second channel therebetween holding water; said first raceway having a living food source within the water and the second raceway having aquatic life within the water; and at least one lighting assembly associated with the first raceway providing light at a first predetermined wavelength related to enhancing growth of the living food source. The system further comprises at least one lighting assembly within the second raceway providing light at a second predetermined wavelength related to enhancing growth of the aquatic life.

WO 01/50845 A1 discloses a system and a method of growing shrimp, allowing balanced processes to accomplish the intensive culture of shrimp while reducing the risk of loss due to disease or environmental contaminants. Specifically, the present invention involves a unique combination of elements including: the use of specific pathogen free marine animal stocks, facilities which are effectively disinfected and isolated from sources of disease vectors and environmental contaminants, a beneficial, synergistic microbial population, and an aqueous medium of controlled composition. The system also comprises a specialized feed for supporting the microorganisms and marine animals, with zero-exchange of aqueous medium throughout the growout cycle such that the solids formed during operation, uneaten feeds, and fecal matter are retained in the system to provide an environment suitable for high yields and growth rates of marine animals. WO 01/50845 A1 further teaches that, in essence, once the microbial population, the shrimp population, and nutrition source are introduced, the system approximates a balanced, self-regulating and self-maintaining system, with the nutrition source and level of aeration as primary control mechanisms of the microbial and shrimp populations.

### SUMMARY OF THE INVENTION

Aquatic species such as fish and crustacea (a group of invertebrate animals including shrimps, prawns, oysters, crabs, lobsters, crayfish, krill, and barnacles) are a growing protein food source for people. In view of management of wild species and ecology, more and more of such species are cultivated in artificial conditions, such as e.g. in offshore sea cages (still making water contact to the natural environment) or in onshore cultivation tanks. A possible effective and ecologically feeding for e.g. shrimp may consists of the use of certain photo-autotrophic organism or diatomic species. Such photo-autotrophic organism feeding source is (also) cultivated artificially, in onshore tanks (bioreactors) and next provided to the shrimp. Hence, production of photo-autotrophic organism may be done separate from the production of the aquatic species, or in a balanced eco-system of connected tanks.

A simple maximization of the yield of the arthropod growth by maximizing photo-autotrophic organism production inside the growth location of the arthropods may not always be desirable, as maximizing photo-autotrophic organism production may also have side effects which may influence the arthropod yield and/or quality. Further, it may be desirable to control a balance between the two species in view of e.g. desirable growth time of the arthropods.

Hence, it is an aspect of the invention to provide an alternative method and/or system, which preferably further at least partly obviates one or more of above-described drawbacks. The present invention may have as object to overcome or ameliorate at least one of the disadvantages of the prior art, or to provide a useful alternative.

Amongst others, the invention proposes growing the photo-autotrophic organisms, such as algae, in the same environment as where the arthropods, such as shrimps, reside, making the system much simpler (one tank for photo-autotrophic organism feed production and shrimp rearing) from the installation perspective, and may also be more space effective. This co-habitation (having living and thriving shrimps and photo-autotrophic organisms together in one environment) may be managed, for which herein a solution may be provided based on balancing this mixed ecosystem with environmental factors such as (primarily) light, temperature, dissolved O₂ and CO₂ levels, nitrate levels, pH, etc.

The invention is defined by a method for growing arthropods and photo-autotrophic organisms in a shared water recipient according to claim 1, an arthropods and photo-autotrophic organism growing system according to claim 12 and a computer program product according to claim 11.

Hence, in a first aspect, a method for growing arthropods and photo-autotrophic organisms in a shared water recipient is provided, wherein the method comprises: (a) monitoring an arthropod monitoring parameter of the arthropods in the shared water recipient, and (b) controlling an photo-autotrophic organism control parameter of the photo-autotrophic organisms in the shared water recipient in dependence of the arthropod monitoring parameter. Especially, the arthropod monitoring parameter may be related to one or more of growth (of the arthropods), metabolism (of the arthropods), and behavior of the arthropods. Further, especially the photo-autotrophic organism control parameter may be chosen to influence one or more of growth and metabolism of the photo-autotrophic organisms. Therefore, especially the method for growing arthropods and photo-autotrophic organisms in a shared water recipient may comprise: (a) monitoring an arthropod monitoring parameter of the arthropods in the shared water recipient, wherein the arthropod monitoring parameter is related to one or more of growth, metabolism, and behavior of the arthropods; and (b) controlling an photo-autotrophic organism control parameter of the photo-autotrophic organisms in the shared water recipient in dependence of the arthropod monitoring parameter, wherein the photo-autotrophic organism control parameter influences one or more of growth and metabolism of the photo-autotrophic organisms.

With such method, it may be possible to grow the arthropods and photo-autotrophic organisms in co-habitation and manage the growth. Further, such method allows keeping the growth of the arthropods and photo-autotrophic organisms in an equilibrium. In this way, control of the photo-autotrophic organism growth may be done in such a way that the growth of the arthropods can be optimized. For instance, yield may be better controlled and/or the growth as such can be better controlled, e.g. in view of market demands.

As indicated above, the method may be a method for growing arthropods and photo-autotrophic organism in a shared water recipient.

The term “arthropod growing” may in embodiments especially refer to arthropod farming. The term “arthropod keeping” may herein refer to the commercial breeding and growing of an arthropod, such as for human consumption, animal feed production, or production of specific substances, such as proteins or medicinal compounds. Arthropods may also be farmed in captivity for agricultural and industrial use. The term “arthropod” may herein refer to a member of the phylum Arthropoda, especially a member of the phylum Euarthropoda. In specific embodiments, the arthropod may comprise a species selected from the group comprising Crustacea, such as crabs, lobsters, crayfish or shrimps. In specific embodiments, the arthropod may comprise a species selected from the group comprising Crustacea and Hexapoda. Herein, the term “arthropod” may especially refer to aquatic arthropods, such as crabs, lobsters, crayfish or shrimps, like especially shrimps. The photo-autotrophic organism are herein especially grown for consumption by the arthropods. Photo-autotrophic organism may especially comprise algae. In embodiments, alternatively or additionally, photo-autotrophic organism may comprise duckweed.

Alternatively or additionally, photo-autotrophic organism may comprise moss. Algae may in embodiments comprise one or more of diatoms, Chlorophyta, Euglenophyta, Dinoflagellate, Chrysophyta, Phaeophyta, Rhodophyta, and Cyanobacteria. Alternatively or additionally, the algae may be selected from Chlorophyceae (green algae), Charophyta, and Streptophyta. Especially, the algae may be selected from the group of chlorophytes. For instance, Chlorophytes, such as of the genus Tetraselmis, or Ochrophyta, such as of the genus Nannochloropsis, may be applied. Alternatively or additionally, cyanobacteria such as of the genus Synechococcus, or diatoms, like Chaetocerossp, may be applied. Alternatively or additionally, e.g. one or more of Rhizosolenia sp., Dinoflagellates (e.g. Gymnodinium) and Flagellates (e.g. Heteromastix), may be applied. Alternatively or additionally to green algae, also brown and/or red algae may be applied. Hence, algae may be applied, especially aquatic algae, such as algae.

The phrase “growing arthropods and photo-autotrophic organisms”, and similar phrases, may further imply in embodiments controlling environmental factors such as (primarily) light, temperature, dissolved O₂ and CO₂ levels, nitrate levels, pH, salinity, etc. (see further also below), such that the arthropods and photo-autotrophic organism can live, or especially grow. The phrase “growing arthropods and photo-autotrophic organisms”, and similar phrases, may further imply in embodiments providing feed to the photo-autotrophic organism, such that the photo-autotrophic organism may grow. The feed for photo-autotrophic organisms may comprise carbon dioxide and other (inorganic nutrients), as known in the art. The phrase “growing arthropods and photo-autotrophic organisms”, and similar phrases, may further imply in embodiments removing liquid and/or sediments from the water recipient. The phrase “growing arthropods and photo-autotrophic organisms”, and similar phrases, may further imply harvesting one or more of growing arthropods and photo-autotrophic organisms. The phrase “growing arthropods and photo-autotrophic organisms”, and similar phrases, may further imply providing light, such as daylight or supplemental light, or specific light during dark periods, to the water recipient.

The term “water recipient” may refer to a (relatively) closed space, such as a water basin, a tank, an aquarium, etc. In further embodiments, the “water recipient” may comprise a (relatively) open space, such as a pond, a field of grass, or a section of a water body, such as a section of a lake, a sea or an ocean. Hence, the “water recipient” may in embodiments be comprised in an indoor space, but may in further embodiments be available in an (open) outdoor space. In specific embodiments, the “water recipient” may be comprised in a greenhouse, especially a tunnel greenhouse. Herein the term “water recipient” may especially refer to such recipient including water.

Further, herein especially the term “shared water recipient” is applied. This term may especially refer to a recipient wherein the arthropods and the photo-autotrophic organism are in the same recipient and due to flow and/or movement may be available, propagate and be moved in the same volume. Hence, the term “shared water recipient” may in embodiments not refer to separate parts of a tank (or other water recipient) wherein one of the species may essentially not be able to move from one of the parts or be moved by flow from one of the parts to another part of the tank or another of the species from another part of the shared water recipient to the one part. Hence, the shared water recipient may provide an essentially spatially non-divided habitat for both species.

Therefore, an photo-autotrophic organism control parameter which may be used to control photo-autotrophic organisms may potentially also influence the arthropods. Additionally or alternatively, an arthropod control parameter which may be used to control arthropods may potentially also influence the photo-autotrophic organisms.

For this reason, the methods and systems disclosed herein may especially provide solutions such that, even while the arthropods and the photo-autotrophic organism are in a shared water recipient, the photo-autotrophic organism may be addressed selectively while not addressing the arthropods and/or the arthropods may be addressed selectively while not addressing the photo-autotrophic organisms. Alternatively or additionally, the methods and systems disclosed herein may especially provide solutions such that, even while the arthropods and the photo-autotrophic organism are in a shared water recipient, the photo-autotrophic organism may be addressed primarily while substantially not addressing or in an opposite way addressing the arthropods and/or the arthropods may be addressed selectively while substantially not addressing the photo-autotrophic organisms or in an opposite way addressing the photo-autotrophic organisms; see also below.

When selectively addressing the arthropod or the photo-autotrophic organisms, they may be individually be controlled.

The term “arthropod control parameter” may also refer to a plurality of different arthropod control parameters. The term “photo-autotrophic organism control parameter” may also refer to a plurality of different photo-autotrophic organism control parameters. The term “arthropod monitoring parameter” may also refer to a plurality of different arthropod monitoring parameters. The term “photo-autotrophic organism monitoring parameter” may also refer to a plurality of different photo-autotrophic organism monitoring parameters.

As indicated above, the method may comprise controlling an photo-autotrophic organism control parameter of the photo-autotrophic organisms in the shared water recipient in dependence of the arthropod monitoring parameter. As indicated above, the photo-autotrophic organism control parameter may influence one or more of growth and metabolism of the photo-autotrophic organisms.

Control parameters that may influence the growth of the photo-autotrophic organism may e.g. include specific feed, not being the feed for the arthropods, such as CO₂ and some inorganic materials that may be used as feed for photo-autotrophic organism, like e.g. sulfur comprising materials, iron comprising materials, trace elements, etc. Another control parameter that may influence the growth of the photo-autotrophic organism may be lighting. Lighting may be controlled with respect to spectral power distribution, intensity, and time-scheme. Further, a control parameter may be temperature. Yet a further parameter may (thus) be CO₂ (dissolved in water). Another control parameter may be the pH. Yet another control parameter may be the electrical conductivity (EC) of the water.

Control parameters that may influence the metabolism may also be selected from one or more of feed, light, and temperature. However, also other parameters as mentioned above may influence the metabolism, like CO₂ concentration, pH, and EC.

Further, control parameters that may influence the growth and/or metabolism may also be selected from one or more of turbulence, flow, turbidity, and salinity.

Amongst others, the method may comprise monitoring an arthropod monitoring parameter of the arthropods in the shared water recipient. Especially, the arthropod monitoring parameter may relate to one or more of growth, metabolism, and behavior of the arthropods.

For instance, the growth of the arthropods may be monitored by analyzing images (over time) of the arthropods, for instance with a camera, and/or by determining their weight (e.g. by taking a sample or by temporarily removing a sample from the water recipient, measuring and/or weighing the arthropod(s) contained in the sample, and reintroducing the arthropod(s) in the shared water recipient). Note that parameters like size and weight may also be a measure of the (efficiency of the) metabolism; see also below. Individual data on the arthropod may not be required and population/statistical data might suffice. However, in case there is a desire to use statistical distribution of e.g. size and/or weight, a data set of individuals or groups may be needed.

For instance, the metabolism of the arthropods may be determined by determining the amount of feed that is retrieved from the water recipient and apparently consumed by the arthropods. This may especially relate to feed comprising the photo-autotrophic organisms. However, this may also relate to feed not comprising the photo-autotropic organisms or not being fed for the photo-autotrophic organism, but e.g. feed that is only consumed by the arthropods (and not by the photo-autotrophic organism). This can be a measure of the (efficiency of the) metabolism. The metabolism of the arthropods may also be determined by determining excretion products, such as the amount or concentration of (liquid and/or solid) excretion products, and/or the composition of the excretion products. This can be a measure of the (efficiency of the) metabolism. Based on the feed that is converted into weight, a feed conversion ratio may be determined. In general, the less feed necessary to gain weight, the more desirable this may be. Feed conversion ratio (FCR) may be defined as the total weight of feed (consumed) divided by the net production (final weight minus starting weight). The lower the value, the more efficient the growing process.

For instance, the behavior of the arthropods may be determined by monitoring images from the arthropods, for instance with a camera, though other methods may also be possible. However, also other methods may be used, like radar and/or microwave, or sonar or Doppler sonar. The behavior of the arthropods may also be determined by monitoring motility, for instance with a camera. The behavior of the arthropods may also be determined by monitoring sound (for instance on the bottom of the water recipient, or at the wall(s), e.g. due to movement of the arthropods). The behavior of the arthropods may also be determined by monitoring reproduction, for instance with a camera or based on sizes, and/or weight and/or number determination, see also above. The number of arthropods may be determined by monitoring with e.g. a camera and/or by taking a sample or by temporarily removing a sample from the water recipient, measuring and/or weighing the arthropod(s) (see also above). The behavior of the arthropods may also be determined from the molting. The number or amount of residual exoskeletons may also be indicative of the behavior (and metabolism). Methods that can be used to monitor the behavior of the arthropods may also be used to monitor the motility.

The behavior may be indicative of the well-being of the arthropods. Too low motility may indicate not enough food or other undesirable conditions. Likewise, a too high motility may also be indicative an absence of well-being or aggression, like e.g. a flight response.

Hence, in embodiments the arthropod monitoring parameter of the arthropods may comprise one or more of (i) a feed conversion ratio of the arthropods, (ii) motility of the arthropods, (iii) size of the arthropods, (iv) reproduction of the arthropods, (v) excretion products of the arthropods, and (vi) molting of the arthropods.

As indicated above, the method may comprise controlling a photo-autotrophic organism control parameter of the photo-autotrophic organisms in the shared water recipient in dependence of the arthropod monitoring parameter. This may be based on feedback (e.g. info provided for a manual intervention) or an automatic feedback loop (e.g. an automated action to correct/bring a control parameter into the required condition).

It may also be desirable to not only control the photo-autotrophic organism control parameter but also to control an arthropod control parameter. For instance, would the arthropods grow fast and not have enough photo-autotrophic organism feed, food production may be increased via the photo-autotrophic organism control parameter and via an arthropod control parameter the arthropods may temporarily be motivated to reduce activity until there is again enough photo-autotrophic organism food. For instance, this may be done via one or more of light, such as a lighting scheme which reduces the day time, or via temperature, which may be regulated a bit lower. Dependent upon the choices, this may also have impact on the photo-autotrophic organisms. Hence, it may be desirable to choose those conditions which lead at a desirable rate to a new equilibrium wherein feed production via photo-autotrophic organism and feed consumption by the arthropods is in equilibrium.

The arthropod control parameter may especially influence one or more of growth, metabolism and behavior of the arthropods.

Control parameters that may influence the growth of the arthropods may e.g. include specific feed, not being the photo-autotrophic organisms. Another control parameter that may influence the growth of the arthropods may be lighting. Lighting may be controlled with respect to spectral power distribution, intensity, and time-scheme. Further, a control parameter may be temperature. Yet a further control parameter may be O₂ (dissolved in water). Yet a further control parameter may be the nitrate concentration.

Control parameters that may influence the metabolism may also be selected from one or more of feed, light, and temperature.

Control parameters that may influence the behavior may also be selected from one or more of feed, light, and temperature. Further, control parameters that may influence the behavior may also be selected from one or more of turbulence, flow, turbidity, and salinity. Yet further control parameters that may influence behavior may e.g. comprise odors and/or pheromones.

The method may comprise controlling an arthropod control parameter of the arthropods in dependence of the arthropod monitoring parameter. Yet further, in specific examples the method may comprise controlling (i) the photo-autotrophic organism control parameter of the photo-autotrophic organism and (ii) an arthropod control parameter of the arthropods in dependence of the arthropod monitoring parameter, wherein the arthropod control parameter influences one or more of growth, metabolism and behavior of the arthropods.

Yet further, the method may also comprise controlling the photo-autotrophic organism control parameter of the photo-autotrophic organism in dependence of an photo-autotrophic organism monitoring parameter. More especially, the method may comprise controlling (i) the photo-autotrophic organism control parameter of the photo-autotrophic organism and (ii) the arthropod control parameter of the arthropods in dependence of the arthropod monitoring parameter and a photo-autotrophic organism monitoring parameter.

In embodiments, the photo-autotrophic organism monitoring parameter may be related to one or more of growth and metabolism of the photo-autotrophic organisms.

For instance, the growth of the photo-autotrophic organism may be monitored by analyzing images of the photo-autotrophic organism, for instance with a camera (over time), and/or by determining their weight (e.g. by taking a sample or by temporarily removing a sample from the water recipient, measuring and/or weighing the photo-autotrophic organism(s) contained in the sample, and optionally reintroducing the photo-autotrophic organism(s) in the shared water recipient). The growth of the photo-autotrophic organisms may also be monitored by determining the photo-autotrophic organism volume. The growth of the photo-autotrophic organisms may also be monitored by determining the turbidity. The growth of the photo-autotrophic organisms may also be monitored by determining the O₂ production. The growth of the photo-autotrophic organisms may also be monitored by determining the CO₂ consumption. An photo-autotrophic organism monitoring parameter may also be the nitrate concentration. The growth of the photo-autotrophic organisms may also be monitored with absorption spectroscopy, which can be used to measure photosynthesis pigment concentrations. The growth of the photo-autotrophic organisms may also be monitored by measuring the photosynthesis efficiency by looking the fluorescence of the chlorophyl.

For instance, the metabolism of the photo-autotrophic organism may be determined by determining the amount of photo-autotrophic organism feed that is retrieved from the water recipient and apparently consumed by the photo-autotrophic organisms. However, this may especially relate to feed not being fed to the arthropods, but e.g. feed that is only consumed by the photo-autotrophic organisms. This can be a measure of the (efficiency of the) metabolism. The metabolism of the photo-autotrophic organisms may also be determined by determining excretion products, such as the amount or concentration of excretion products (and/or the composition of the excretion products). This can be a measure of the (efficiency of the) metabolism.

Hence, in embodiments the photo-autotrophic organism monitoring parameter of the photo-autotrophic organism may comprise one or more of (i) a feed conversion ratio of the photo-autotrophic organisms (CO₂ consumption), (ii) size of the photo-autotrophic organisms, and (iii) excretion products (O₂ production) of the photo-autotrophic organisms.

As indicated above, the method may allow keeping the growth of the arthropods and photo-autotrophic organisms in an equilibrium, at least during part of the growing time. The growing time of arthropods, such as shrimps, may be in the order of e.g. 2-4 months, but may also be longer, e.g. in the case of lobsters or crabs. For instance, the growing time of lobsters may be about 6-7 months and for (some) crabs, the growing time may be about in the range of 3-6 months.

Over time, an equilibrium between the growth of the photo-autotrophic organisms and of the arthropods may change. When the arthropods are smaller or younger, the photo-autotrophic organism growth may be lower. When the arthropods are larger or older, the photo-autotrophic organism growth may be higher. When part of the arthropods have been harvested, again the photo-autotrophic organism growth may be smaller. When it is expected there is a larger or smaller demand in future for the arthropods, the photo-autotrophic organism growth may be stimulated or reduced. When changing from one equilibrium to another equilibrium, there may be intermediate equilibria. However, in some instances there may also be disruptions from equilibria, like in the case of harvesting, sudden temperature changes, etc., or anomalies such as (massive) death of arthropods, runaway of chemical composition of the water because of e.g. rain (dilution effect), etc. An equilibrium in this context may e.g. be defined as being a predominantly steady state situation during which the arthropods show reproducible growth, metabolism, and behavior.

Hence, in embodiments the method may comprise maintaining during at least part of a growth time an equilibrium between (growth of) the arthropods and (growth of) the photo-autotrophic organisms. Especially, the method may comprise maintaining during at least part of a growth time an equilibrium between photo-autotrophic organism feed consumption by the arthropods and growth of the photo-autotrophic organisms.

Especially, it may be desirable when controlling the photo-autotrophic organism control parameter, this essentially only influences the photo-autotrophic organism and not the arthropods (at least not directly; indirectly due to changes in photo-autotrophic organism growth, an influence on the arthropods may be obtained). Hence, in specific examples controlling the photo-autotrophic organism control parameter may comprise selectively influencing the one or more of growth and metabolism of the photo-autotrophic organisms. When selectively influencing the one or more of growth and metabolism of the photo-autotrophic organism, the one or more of growth, metabolism and behavior of the arthropods may essentially not be influenced.

For instance, by controlling the photo-autotrophic organism control parameter it may be possible to promote one or more of growth and metabolism of the photo-autotrophic organism while not promoting the growth and metabolism of the arthropods. Alternatively, in embodiments by controlling the photo-autotrophic organism control parameter it may be possible to promote one or more of growth and metabolism of the photo-autotrophic organism while slowing down the growth and metabolism of the arthropods. In this way, it may be possible to selectively influence the growth and/or metabolism of the photo-autotrophic organisms.

In yet other examples, by controlling the photo-autotrophic organism control parameter it may be possible to reduce one or more of growth and metabolism of the photo-autotrophic organism while not reducing the growth and metabolism of the arthropods. Alternatively, by controlling the photo-autotrophic organism control parameter it may be possible to reduce one or more of growth and metabolism of the photo-autotrophic organism while promoting down the growth and metabolism of the arthropods.

Hence, controlling the photo-autotrophic organism control parameter may comprise promoting the one or more of growth and metabolism of the photo-autotrophic organism while not promoting or while slowing down one or more of growth and metabolism of the arthropods.

Yet further, by controlling the photo-autotrophic organism control parameter it may be possible to promote or reduce one or more of growth and metabolism of the photo-autotrophic organism while having substantially no impact on the behavior of the arthropods. Yet further, by controlling the photo-autotrophic organism control parameter it may be possible to promote or reduce one or more of growth and metabolism of the photo-autotrophic organism while having an impact on the behavior of the arthropods which may lead to a reduction or promotion (i.e. opposite to the impact on the photo-autotrophic organism growth or metabolism) of the growth or metabolism of the arthropods.

In specific examples, an effect on the growth or metabolism of the photo-autotrophic organism may also have an impact on the growth or metabolism of the arthropods, though in a lesser extent. In this way, a partly selective control may be applied, which may also lead to a new equilibrium. For instance, controlling the photo-autotrophic organism control parameter may comprise promoting the one or more of growth and metabolism of the photo-autotrophic organisms with a first rate R1 and promoting the one or more of growth and metabolism of the arthropods with a second rate R2, wherein R2/R1≤0.75. When R2/R1=0, then the photo-autotrophic organism parameter may essentially be a selective control parameter. Especially, in embodiments 0≤R2/R1<0.5. The ratio may in specific embodiments also be negative. The first rate or second rate may e.g. be metabolic rates or feed conversion rates. In embodiments, R1>0 and R2>0. Especially, R1 may refer to a growth rate or a metabolic rate of the photo-autotrophic organisms. Especially, R2 may refer to a growth rate or a metabolic rate of the arthropods. When comparing R1 and R2, in embodiments either the growth rates or the metabolic rates may be used.

Not only may the photo-autotrophic organism control parameter be controlled in dependence of the arthropod monitoring parameter, also the arthropod control parameter may be controlled in dependence of the arthropod monitoring parameter. Alternatively or additionally, the arthropod control parameter may be controlled in dependence of the photo-autotrophic organism monitoring parameter.

Hence, controlling the arthropod control parameter may comprise (selectively) promoting the one or more of growth and metabolism of the arthropod by providing arthropod light (21) having a second spectral power distribution and according to a second time-intensity scheme.

Controlling the arthropod control parameter may comprise selectively influencing the one or more of growth and metabolism of the arthropods. Yet further, in specific examples controlling the arthropod control parameter may comprise promoting the one or more of growth and metabolism and behavior of the arthropods while not promoting or while slowing down one or more of growth and metabolism of the photo-autotrophic organisms.

Spectral power distributions may be chosen which are beneficial for the arthropods or which activate arthropods, but which have essentially no influence on the photo-autotrophic organisms. In other examples, spectral power distributions may be chosen which are beneficial for the photo-autotrophic organism, but which essentially have no influence on the photo-autotrophic organisms. Here, “beneficial” may indicate that they may gain weight, gain useful nutritional compounds, etc.

Alternatively or additionally, a lighting scheme may be chosen which has a higher impact on the arthropods, such as that they are promoted to gain weight more, than on photo-autotrophic organism (such that they are promoted less or are not promoted). Alternatively or additionally, a lighting scheme may be chosen which has a higher impact on the photo-autotrophic organism, such as that they are promoted more, than on arthropods (such that they are promoted less or are not promoted).

Hence, controlling the photo-autotrophic organism control parameter may comprise selectively promoting the one or more of growth and metabolism of the photo-autotrophic organism by providing photo-autotrophic organism light having a first spectral power distribution and according to a first time-intensity scheme.

Herein the term “photo-autotrophic organism light” may especially refer to light having a spectral power distribution that may activate photo-autotrophic organism to gain weight and/or to reproduce, e.g. light that activates the metabolism of the photo-autotrophic organism and/or the reproduction of the photo-autotrophic organisms. This may substantially be controlled by the photosynthesis, in which the necessary glucose is made for growth. Especially, such photo-autotrophic organism light has a lower impact on the activation or no impact on the activation of arthropods. The term “photo-autotrophic organism light” may in specific examples also refer to light that may selectively slow down the metabolism of the photo-autotrophic organism, while having essentially no impact on the arthropods.

Herein, the term “arthropod light” may especially refer to light having a spectral power distribution that may activate arthropods to gain weight, e.g. light that activates the metabolism of the arthropods. Especially, such arthropod light has a lower impact on the activation or no impact on the activation of photo-autotrophic organisms. The term “photo-autotrophic organism light” may in specific examples also refer to light that may selectively slow down the metabolism of the arthropods or having impact on the behavior of the arthropods, while having essentially no impact on the photo-autotrophic organisms.

The photo-autotrophic organism light may be provided as such, or may be provided as supplemental light. The photo-autrophic organism light may be different from the arthropod light. Especially, the spectral power distribution of photo-autrophic organism light may be different from the spectral power distribution of the arthropod light.

For instance, photo-autotrophic organism light may have intensity at wavelengths selected from the range of 600-720 nm, especially 620-700 nm and/or intensity at wavelengths selected from the range of 600-680 nm, especially 620-680 nm. These wavelength ranges may especially be based on the (photosynthesis) action spectra of photo-autotrophic organisms. For instance, in specific embodiments photo-autotrophic organism light may have a peak wavelength within the range of 600-720 nm, especially 620-700 nm and/or a peak wavelength within the range of 600-680 nm, especially 620-680 nm. For instance, in embodiments the spectral power distribution of photo-autotrophic organism light may comprises at least 20% of the spectral power in the wavelength range of 400-800 nm within the wavelength range of 620-700 nm and less than 30% of the spectral power in the 480-620 nm wavelength range. In other words, when the spectral power of the photo-autotrophic organisms light in the wavelength range of 400-800 nm is 100%, at least 20% thereof may be found in the 620-700 nm range and less than 30% thereof may found in the wavelength range of 480-620 nm. Therefore, the first spectral power distribution of photo-autotrophic organism light may comprises at least 20%, even more especially at least 30% of the spectral power in the wavelength range of 400-800 nm within the wavelength range of 620-700 nm and less than 30% of the spectral power in the 480-620 nm wavelength range. Yet, in embodiments the first spectral power distribution of photo-autotrophic organism light may comprises at least 70%, of the spectral power in the wavelength range of 400-800 nm within the wavelength range of 620-700 nm. Spectral powers may be indicated in Watts.

For instance, in embodiments arthropod light may have intensity at wavelengths selected from the range of 480-620 nm, especially 500-600 nm, even more especially selected from the range of 510-560 nm. These wavelength ranges may especially be based on the action spectra of arthropod, specifically the spectral sensitivity of the photoreceptors influencing their activity level and circadian system. For instance, in specific embodiments arthropod light may have a peak wavelength within the range of 480-620 nm, especially 500-600 nm, even more especially within the range of 510-560 nm. For instance, in specific embodiments, the spectral power distribution of the arthropod light comprises at least 80% of the spectral power in the wavelength range of 400-800 nm within the wavelength range of 480-620 nm. Or in other words, when the spectral power of the arthropod light in the wavelength range of 400-800 nm is defined as 100%, at least 80% thereof may be found in the 480-620 nm wavelength range, even more especially in the 500-600 nm wavelength range, such as yet even more especially in the 510-560 nm wavelength range. Therefore, the second spectral power distribution may comprise at least 80% of the spectral power in the wavelength range of 400-800 nm within the wavelength range of 480-620 nm.

Further, during part of the life cycle or during part of the 24 hour cycle the arthropods may desire another water depth than during another part of the life cycle or during part of the 24 hour cycle. Alternatively or additionally, during part of the life cycle or during part of the 24 hour cycle the photo-autotrophic organism may desire another water depth than during another part of the life cycle or during part of the 24 hour cycle. Hence, in examples the spectral power distribution and/or time-scheme of the light that is introduced in the water recipient may be dependent upon the depth (of where the light is introduced). Hence, the method may comprise introducing the photo-autotrophic organism light at a controlled depth (where the light is introduced in the share water recipient) in the shared water recipient and controlling one or more of the first spectral power distribution and the first time-intensity scheme in dependence of the depth (d1). Alternatively or additionally, the method may comprises introducing the arthropod light at a controlled depth (d1) in the shared water recipient and controlling one or more of the second spectral power distribution and the first time-intensity scheme in dependence of the depth (d1).

Hence, described herein is also a spatially controllable light system (application), such that e.g. only part of the water recipient receives light (e.g., where the shrimp reside, e.g. at the bottom) while another part of the recipient (e.g., where the photo-autotrophic organism float around) is not provided with light. This may for example lead to arthropods being promoted, because of receiving good light conditions, and thus improved thrive of the arthropods is achieved, while photo-autotrophic organism statistically getting lower light levels, and thus reproduction thereof is lowered. Of course, alternatively the system may be applied the other way around, i.e., providing good light conditions for the photo-autotrophic organisms, e.g., at the top of the recipient, while shrimp receive only limited arthropod light, e.g., at the bottom of the recipient.

Alternatively or additionally, a lighting scheme may be chosen which has a higher impact on the photo-autotrophic organisms, such as that they are promoted more, than on arthropods, such that they are promoted less or are not promoted. For instance, during at least part of a time that artificial light is provided to the water recipient, the intensity of the light, may be chosen such that the intensity is higher than a minimum level necessary for the arthropods. When further increasing the intensity, this may have impact on the photo-autotrophic organism, but have less or no further impact on the arthropod. Hence, in embodiments the photo-autotrophic organism control parameter may be a light intensity parameter. This may be of especially relevance when light is used with wavelengths which may activate both the photo-autotrophic organisms and the arthropods. For instance, this may be the case when light is provided with a photon intensity of at least 200 μmol/sec/m². For instance, doubling the light level from 200 to 400 μmol/sec/m² may (almost) double the photo-autotrophic organism production while having essentially no impact on the arthropods. Here, the μmols refer to the number of photons, and the area of a water surface may be used as reference area.

In yet other embodiments, a lighting scheme is chosen wherein the arthropod receive arthropod light during only part of the day, and thus also experience a dark period, whereas during (a large part of) this dark period photo-autotrophic organism is provided having essentially no intensity in the wavelength ranges of the arthropod light. Hence, for the arthropod there may be a light period L2 and a dark period D2, wherein L2+D2=24 h, and wherein in examples especially L2 is at least 8 h, and wherein D2 may be at least 2 h.

Further, for the photo-autotrophic organism there may be a light period L1 and a dark period D1, and wherein in examples especially L1 is at least 12 h and wherein D1 may be less than 10 h, such as less than 5 h. Especially, D1<D2. In specific examples, D1 may be in the order of 0.5-3 h. In specific examples, the lighting period for photo-autotrophic organisms may even be longer than 24 hours, i.e., de facto having D1 equal to zero.

During L2 arthropod light may be provided and during D2 essentially no arthropod light may be provided. The time integrated intensity of the arthropod light in the L2 period may be at least 5 times larger than the time integrated intensity of the arthropod light in the D2 period.

During L1 photo-autotrophic organism light may be provided and during D1 essentially no photo-autotrophic organism light may be provided. The time integrated intensity of the photo-autotrophic organism light in the L1 period may be at least 5 times larger, such as at least 10 time larger, than the time integrated intensity of the photo-autotrophic organism light in the D1 period. As indicated above, there may even be no D1 period, i.e. in embodiments 24/7 photo-autotrophic organism light.

Hence, as described above the photo-autrophic organism may be different from the arthropod light in that the time-intensity scheme of the photo-autrophic organism light may be different from time-intensity scheme of the arthropod light.

Nitrate may be a by-product of arthropod growth, such as shrimp growth. The nitrate may be used by the photo-autotrophic organisms. A too high nitrate concentration, however, may have negative impact on the arthropod and may lead to a reduction in growth rate and/or a reduction in metabolic activity of the arthropod. This may also apply to an ammonium concentration. By using nitrate and/or ammonium scavengers, or by controlling the concentration by addition of nitrate and/or ammonium to increase the concentration or by water purification or recycling to reduce the concentration, the concentration of nitrate and or ammonium may be controlled. In examples, the photo-autotrophic organism control parameter may be selected from the group of (i) an ammonium concentration and (ii) a nitrate concentration in water in the water recipient. Note that the nitrate (and/or ammonium) concentration may be used to promote photo-autotrophic organism growth and to slow down arthropod growth. In yet further examples, the photo-autotrophic organism control parameter may comprise a phosphate concentration.

In examples, an ammonium concentration may be maintained below about 0.7 mg/L. However, would one desire to reduce the number of arthropods, one may temporarily increase the concentration, e.g. in the range of about 0.5-0.7 mg/L.

In examples, a nitrate concentration may be maintained below about 0.45 mg/L. However, would one desire to reduce the number of arthropods, one may temporarily increase the concentration, e.g. in the range of about 0.45-1 mg/L.

Alternatively or additionally, a temperature may be chosen which has a higher impact on the arthropods, such as that they are promoted to gain weight more, than on photo-autotrophic organism, such that they are promoted less or are not promoted. Alternatively or additionally, a temperature may be chosen which has a higher impact on the photo-autotrophic organism, such as that they are promoted more, than on arthropods, such that they are promoted less or are not promoted. For instance, the temperature may be maintained within a range of about 20-30°. At these temperatures, especially photo-autotrophic organism may be promoted. At lower or higher temperatures, photo-autotrophic organism may be less promoted.

Alternatively or additionally, the O₂ concentration in the water may be chosen which may have a higher impact on the arthropods, such as that they are promoted to gain weight more, than on photo-autotrophic organism, such that they are promoted less or are not promoted. Alternatively or additionally, a CO₂ concentration in the water may be chosen which may have a higher impact on the photo-autotrophic organism, such as that they are promoted more, than on arthropods, such that they are promoted less or are not promoted.

As indicated above, maximizing growth of the arthropod may in embodiments be controlled in time. This may be better for the arthropod quality, such as obtaining a healthy balance of accumulating useful materials and/or preventing accumulation of less desired material. For instance, it may be desirable to reduce stress. However, also in view of expected market demand it may be desirable to be able to tune the time the arthropods can be harvested. In this way, an equilibrium can be chosen at a higher growth rate or an equilibrium can be chosen at a lower growth rate. Over time, this may be adapted, e.g. in view of market demand. Hence, the method may comprise cultivating the arthropods according to a predefined growth scheme, and controlling the photo-autotrophic organism control parameter of the photo-autotrophic organism in the shared water recipient in dependence of (the arthropod monitoring parameter and) the predefined growth scheme of the arthropods. Note that the predefined growth scheme may in specific examples be controllable in the sense that the predefined growth scheme may be changes from a faster growth to a slower growth or vice versa.

As indicated above, the method may comprise controlling a photo-autotrophic organism control parameter of the photo-autotrophic organisms in the shared water recipient in dependence of the arthropod monitoring parameter. The method may further comprise controlling an arthropod control parameter of the arthropods in dependence of the arthropod monitoring parameter. In specific examples, the method may (also) comprise monitoring a photo-autotrophic organism monitoring parameter of the photo-autotrophic organism in the shared water recipient, and controlling the photo-autotrophic organism control parameter of the photo-autotrophic organism in the shared water recipient in dependence of (the arthropod monitoring parameter and) the photo-autotrophic organism monitoring parameter. Therefore, in specific examples the method may comprise controlling (i) the photo-autotrophic organism control parameter of the photo-autotrophic organism and (controlling) (ii) the arthropod control parameter of the arthropods in dependence of the arthropod monitoring parameter and an photo-autotrophic organism monitoring parameter.

The above-method may be executed with a control system. The control system may operate on the basis of a computer program product comprising instructions for execution of the method. Hence, in another aspect, a computer program product comprising instructions for execution on a computer functionally coupled to an arthropods and photo-autotrophic organism growing system wherein the instructions, when executed by the computer, cause the arthropods and photo-autotrophic organism growing system to carry out the method as defined herein, is provided.

The monitoring parameters may be determined with one or more sensors. Monitoring may be done permanently or intermittently. Monitoring can be done in situ, in the sense that the photo-autotrophic organism and/or arthropod are within the water recipient, even though the sensor may in embodiments be external from the shared water recipient, like a camera external from the water recipient (of course, a camera may also be configured within the recipient). Monitoring can also be done ex situ, e.g. by retrieving a sample and determining the monitoring parameter.

The one or more sensors may be selected from cameras, optical detectors, microwave/radar detectors, sonar, Doppler sonar, temperature sensors, flow sensors, weighing devices, pH sensors, concentration determining sensors (e.g. via chemical or optical methods (such as e.g. dissolved O₂ and CO₂ level sensors), particle sensors (such as via the afore-mentioned optical detectors), sound sensors (microphones), EC sensors, etc.

Controlling a control parameter may be done with one or more devices (“actuators” or “controlling devices”). Controlling can be done permanently or intermittently. Controlling can be done by executing an action in the water recipient. Controlling can also be done by providing water to the water recipient containing material of having a specific temperature, or having a specific concentration of the materials. Controlling can be done by retrieving material from the water recipient, such as by removing water, or by removing sediment, or by removing photo-autotrophic organism (or by removing arthropods), etc.

The one or more devices may be selected from heaters, coolers, flow controllers, mixers, water jets, air jets, aerators, additive controllers (like feeders), material scavengers, sieving devices, filtering devices, lighting devices, disinfection equipment, etc.

Lighting devices may be configured within the water recipient. Alternatively or additionally, lighting devices may be configured external from the water recipient. In embodiments, the position of one or more lighting devices may be controllable.

Hence, in another aspect, an arthropods and photo-autotrophic organism growing or keeping system (“system”) is provided comprising (i) a water recipient for hosting a liquid with the arthropods and photo-autotrophic organisms, and (ii) a control system. In specific examples, the control system is configured to execute the method(s) described herein. In examples the arthropods and photo-autotrophic organism growing or keeping system comprises (i) a water recipient for hosting a liquid with the arthropods and photo-autotrophic organisms, (ii) one or more sensors, (iii) one or more controlling devices, and (iv) a control system, wherein the control system is configured to execute the method according as described herein in dependence of a sensor signal of the one or more sensor and with the one or more controlling devices.

The one or more of the controlling devices may comprise a light generating system configured to generate system light. The system light may have a controllable spectral power distribution. Especially, in examples in an operational mode of the light generating system the system light may comprise photo-autotrophic organism light having a first spectral power distribution and the system light may be provided according to a first time-intensity scheme. Yet, in other examples in an (other) operational mode of the light generating system the system light may comprise arthropod light having a second spectral power distribution and the system light may be provided according to a second time-intensity scheme. In examples, the periods wherein photo-autotrophic organism light is provided may partially overlap in time or not overlap in time with the periods that arthropod light is provided.

The term “light generating system” may herein refer to a system comprising one or more light generating devices. In examples, the light generating system may be a light generating device. In further examples, the light generating system may comprise a plurality of (different) light generating devices, and especially a control system configured to (individually) control the plurality of light generating devices. The light generating devices may comprise one or more solid state light sources, such as LEDs, lasers, or superluminescent diodes.

In examples, the system may further comprise a behavioral sensor. The behavioral sensor may be configured to detect an arthropod activity and to provide a related behavioral signal to the control system. In particular, the behavioral sensor may sense feeding or movement activity of the arthropod and the control system may control the system light based on this information.

In examples, the system may comprise a biometric sensor. The biometric sensor may be configured to determine a biometric parameter, especially one or more of body size (distribution), weight (distribution), and development stage of the arthropod(s), and may provide a biometric signal to the control system. The control system may be configured to control the system light based on the biometric signal.

In examples, the system may comprise an environmental sensor. The environmental sensor may be configured to detect an environmental parameter and to provide a related environmental signal to the control system, especially wherein the environmental parameter is selected from the group comprising a temperature, a salinity, and any other chemical or particle composition and concentration. In particular, the environmental parameter may relate to the environment the arthropod is exposed to, such as a temperature and/or a salinity of the water. The control system may be configured to control the system light based on the environmental signal.

In particular, the environmental sensor may sense an abiotic parameter in the water recipient, such as temperature, salinity, and the control system may adapt the settings for one or more of photoperiod, light levels or spectral power distribution (in order to achieve a desired effect). The desired effect may, for example, be accelerating growth, or keeping growth constant.

The methods and systems are especially described in relation to algae. However, instead of algae, or in addition to algae, other aquatic plant-based feed may be applied. In general, the embodiments described herein in relation to algae may also relate to other aquatic plant-based feed, which are herein comprised by the term “photo-autotrophic organism”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1e schematically depicts some embodiments and aspects. The schematic drawings are not necessarily on scale.

### DETAILED DESCRIPTION OF THE EMBODIMENTS

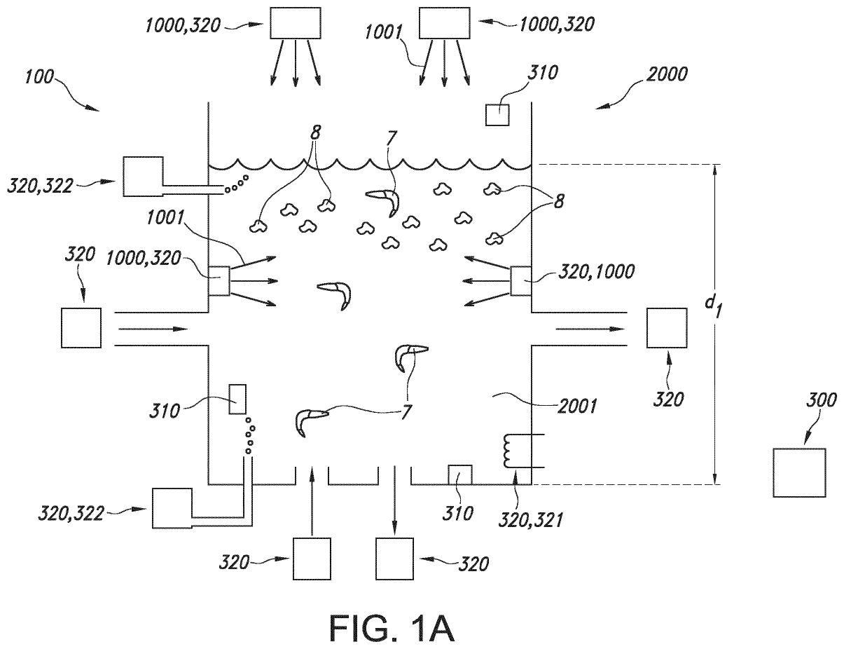

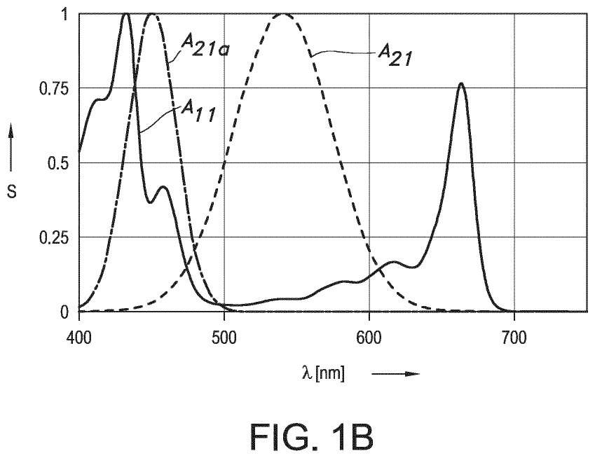

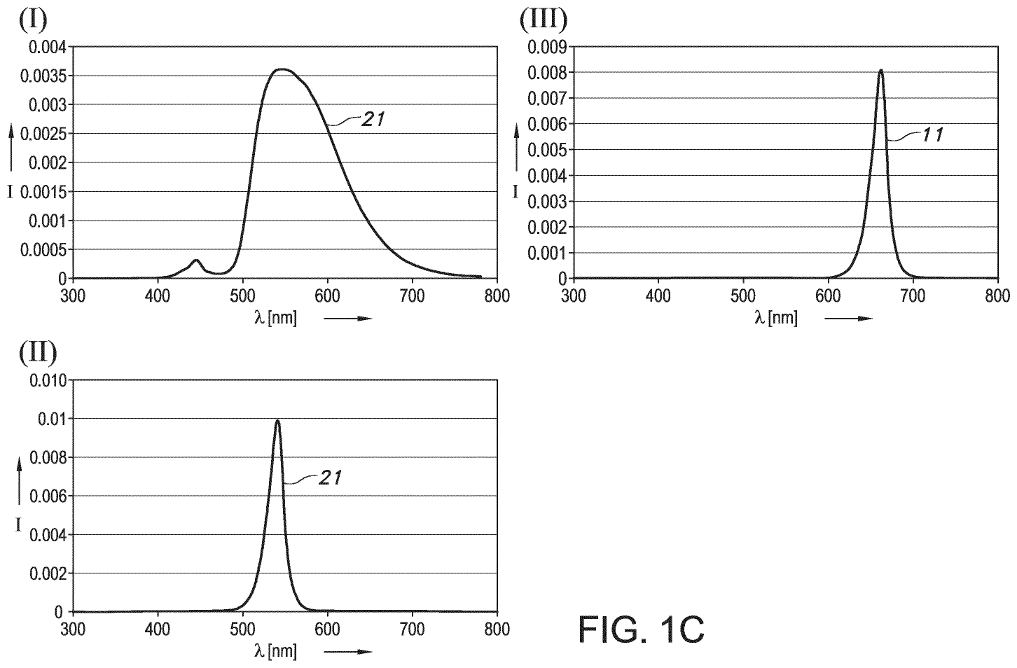

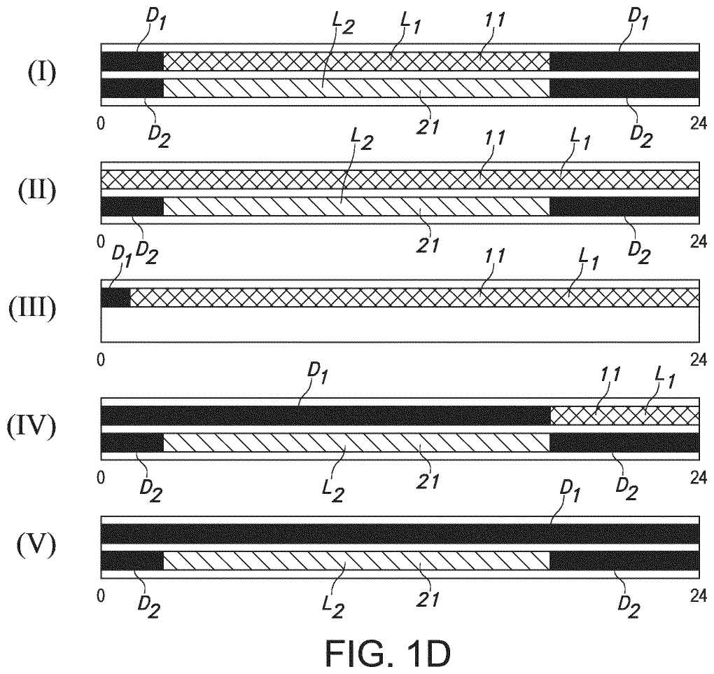

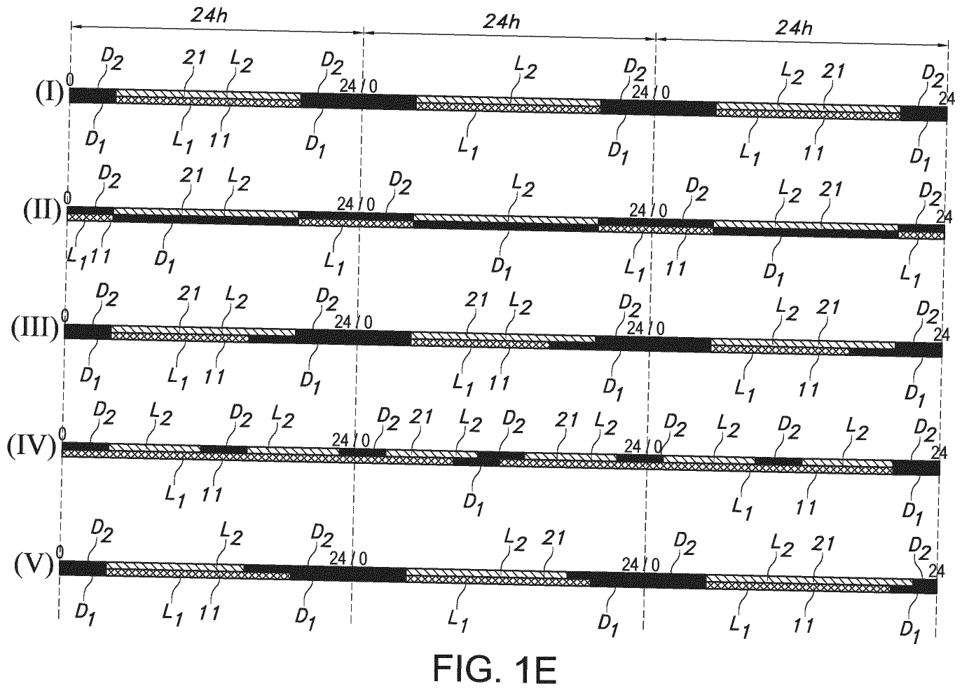

FIG. 1a schematically depicts an example of an arthropods and photo-autotrophic organism growing system 100. The system comprising a water recipient 2000 for hosting a liquid 2001 with the arthropods 7 and photo-autotrophic organisms 8. For instance, in examples the arthropods 7 may comprise a species selected from the group comprising Crustacea and Hexapoda. The photo-autotrophic organisms 8 may e.g. comprise especially green algae, like in examples algae (such as Chlorophyta and Charophyta/Streptophyta) or other species (see also above). The arthropods 7 may in examples comprise shrimps.

Hence, in examples the arthropod comprises a species selected from the group comprising Crustacea and the photo-autotrophic organism comprise algae.

The system 100 may further comprise one or more sensors 310. Yet further, the system 100 may comprise one or more controlling devices 320. The system 100 may also comprise a control system 300. Especially, the control system 300 may be configured to execute the method as described herein in dependence of a sensor signal of the one or more sensors 310 and with the one or more controlling devices 320. In specific examples, the one or more of the controlling devices 320 comprises a light generating system 1000 configured to generate system light 1001. Especially, the system light 1001 may have a controllable spectral power distribution. In other examples, the controlling devices 320 may comprise water purifiers, water enrichers with additives and/or CO₂ introduces and/or O₂ introduces (indicated with reference 322), sieves, temperature control elements (indicated with reference 321), etc. Reference d1 indicates the depth. Note that CO₂ and O₂ may also be provided at different heights within the water recipient 2000, as CO₂ may promote photo-autotrophic organisms and O₂ may promote arthropods.

With reference to also FIGS. 1c (and 1d), in an operational mode of the light generating system 1000 the system light 1001 comprises photo-autotrophic organism light 11 (and/or arthropod light 21) having a first spectral power distribution and the system light 1001 is provided according to a first time-intensity scheme. As schematically depicted, the overlap between the photo-autotrophic organism light 11 and the arthropod light 21 may be (very) low, such as less than 50%, more especially than 25%, like less than 15% of the spectral power distribution having the smallest integrated area (with on the x-scale wavelength and on the y-scale energy). Referring to examples II and III, there is essentially no overlap. Referring to examples I and III there is some overlap. Overlap between spectral power distributions can be determined when the spectral power distributions are normalized to each other. Note that most relevant is the overlap of the spectral power distributions with the activation spectra, see also FIG. 1b, which is further discussed below.

The invention also provides a method for growing arthropods and photo-autotrophic organism in a shared water recipient 2000, which may e.g. be executed with the system 100 as described herein.

In examples, the method for growing arthropods and photo-autotrophic organism in a shared water recipient 2000 comprises: monitoring an arthropod monitoring parameter of the arthropods in the shared water recipient, wherein the arthropod monitoring parameter is related to one or more of size or weight, growth, metabolism, and behavior of the arthropods; and controlling an photo-autotrophic organism control parameter of the photo-autotrophic organism in the shared water recipient in dependence of the arthropod monitoring parameter, wherein the photo-autotrophic organism control parameter influences one or more of growth and metabolism of the photo-autotrophic organisms. Monitoring can be executed with one or more of the sensors 310 and controlling can be executed with one or more devices 320.

In specific examples, the method may comprise controlling the photo-autotrophic organism control parameter of the photo-autotrophic organism and an arthropod control parameter of the arthropods in dependence of the arthropod monitoring parameter, wherein the arthropod control parameter influences one or more of growth, metabolism and behavior of the arthropods. Especially, the method may comprise controlling the photo-autotrophic organism control parameter of the photo-autotrophic organism and the arthropod control parameter of the arthropods in dependence of the arthropod monitoring parameter and an photo-autotrophic organism monitoring parameter, wherein the photo-autotrophic organism monitoring parameter may be related to one or more of growth and metabolism of the photo-autotrophic organisms.

In further specific examples, the method may comprise maintaining during at least part of a growth time an equilibrium between (growth of) the arthropods and (growth of) the photo-autotrophic organisms. In examples, controlling the photo-autotrophic organism control parameter may comprise selectively influencing the one or more of growth and metabolism of the photo-autotrophic organisms. Further, in examples controlling the photo-autotrophic organism control parameter may comprise promoting the one or more of growth and metabolism of the photo-autotrophic organism while not promoting or while slowing down one or more of growth and metabolism of the arthropods. Especially, in examples controlling the photo-autotrophic organism control parameter may comprise promoting the one or more of growth and metabolism of the photo-autotrophic organism with a first rate R1 and promoting the one or more of growth and metabolism of the arthropods with a second rate R2, wherein R2/R1≤0.75. Further, in specific examples controlling the photo-autotrophic organism control parameter may comprise selectively promoting the one or more of growth and metabolism of the photo-autotrophic organism by providing photo-autotrophic organism light 11 having a first spectral power distribution and according to a first time-intensity scheme.

In examples, light level, spectral power distribution, photoperiod, temperature of water, nutrient content of water, pH, CO₂ concentration in water, may especially be used as photo-autotrophic organism control parameter.

Referring to FIG. 1b, an action spectrum for shrimps, indicated with reference A21 is indicated, and action spectra for photo-autotrophic organism, indicated with reference A11. Reference A21 refers to the opnG photoreceptor; reference A21a refers to the CRY1 photoreceptor, and reference A11 refers to the Ch1 A photoreceptor. Green light may have relatively little effect on the algae, but may be a relatively strong stimulus for the shrimp/arthropod biological clock, stimulating growth and activity. Deep red on the other hand may be relatively very effective for photosynthesis of algae, but may have relatively no effect on shrimps/arthropod. Blue light however, may have effects on both algae and shrimps. Referring to FIG. 1c, three possible spectral distributions are shown, with in examples I and II examples of arthropod light 11, though example I may also activate to some extend algae. Example III shows algae light 11 which may essentially only activate algae.

Referring to FIG. 1c, controlling the arthropod control parameter may comprise promoting the one or more of growth and metabolism of the arthropod by providing arthropod light 21 having a second spectral power distribution and according to a second time-intensity scheme; wherein the second spectral power distribution comprises at least 80% of the spectral power in the wavelength range of 400-800 nm within the wavelength range of 480-620 nm (examples I and III), and wherein the first spectral power distribution of photo-autotrophic organism light 11 comprises at least 20% of the spectral power in the wavelength range of 400-800 nm within the wavelength range of 620-700 nm and less than 30% of the spectral power in the 480-620 nm wavelength range (example III). In example II, essentially 100% of the spectral power in the 400-480 nm wavelength range of the arthropod light 21 is in the wavelength range of 480-620 nm. In example III, essentially 100% of the spectral power in the 400-480 nm wavelength range of the photo-autotrophic organisms light 11 is in the wavelength range of 620-700 nm.

Referring to FIGS. 1c and 1d, spectral power distributions may thus be chosen which are beneficial for the arthropods or which activate arthropods, but which have essentially no influence on the photo-autotrophic organisms; and spectral power distributions may thus be chosen which are beneficial for the photo-autotrophic organism, but which essentially have no influence on the photo-autotrophic organisms.

FIG. 1d schematically depicts a number of light settings wherein the light is periodically provided. Example I may overlap in time. As the spectral power distributions of the light 11,21 may be different, activation may still be selective. In example II, the arthropod light 21 is on during part of the day, whereas photo-autotrophic organism light 11 may be during the entire day. Example III shows an example wherein only photo-autotrophic organism light 11 may be provided, with a short dark period D1, such as 0.5-3 hours. This may e.g. be the case when the photo-autotrophic organism metabolism has to be sped up. An opposite example of examples III is shown in example V. Example IV shows alternating lighting periods. This may e.g. be used when a more subtle control is required (see also below). Note that the arthropod light 21 may especially be provided not full-time.

For instance, in examples dosing of CO₂ and O₂ may be used to (selectively) control growth of the different species. Especially, shrimp or other arthropod species may use O₂ and produce CO₂, whereas the photo-autotrophic organism produce O₂ and consume CO₂ during daytime and consume (a bit of) O₂ during nighttime. Dosing O₂ during daytime may selectively increase growth of arthropods and/or dosing CO₂ during the daytime may selectively increase growth of the photo-autotrophic organisms.

For instance, referring to FIG. 1a in examples the method may comprise introducing the photo-autotrophic organism light 11 at a controlled depth d1 in the shared water recipient 2000 and controlling one or more of the first spectral power distribution and the first time-intensity scheme in dependence of the depth d1.

Further, in specific examples the photo-autotrophic organism control parameter may be selected from the group of (i) an ammonium concentration and (ii) a nitrate concentration in water in the water recipient 2000.

Yet, in examples, the arthropod monitoring parameter of the arthropods may comprise one or more of (i) a feed conversion ratio of the arthropods, (ii) motility of the arthropods, (iii) size of the arthropods, (iv) reproduction of the arthropods, (v) excretion products of the arthropods, and (vi) molting of the arthropods. As indicated above, monitoring can be executed with one or more of the sensors 310.

In specific examples, the method may comprise cultivating the arthropods according to a predefined growth scheme, and wherein the method may comprise controlling the photo-autotrophic organism control parameter of the photo-autotrophic organism in the shared water recipient in dependence of (the arthropod monitoring parameter and) the predefined growth scheme of the arthropods.

In yet further specific examples, the method may comprise: (a) monitoring an photo-autotrophic organism monitoring parameter of the photo-autotrophic organisms in the shared water recipient, wherein the photo-autotrophic organism monitoring parameter may be related to one or more of growth and metabolism of the photo-autotrophic organisms; and (b) controlling the photo-autotrophic organism control parameter of the photo-autotrophic organisms in the shared water recipient in dependence of (the arthropod monitoring parameter and) the photo-autotrophic organism monitoring parameter). Especially, controlling the arthropod control parameter may comprise (selectively) promoting the one or more of growth and metabolism of the arthropods by providing arthropod light 21 having a second spectral power distribution and according to a second time-intensity scheme.

FIG. 1e schematically depict possible examples of arthropod and photo-autotrophic organism lighting. Here, by way of example five examples are depicted, with in each example the lighting scheme for the arthropod in the top bar and the lighting scheme for the photo-autotrophic organism in the lower bar.

In examples I, there is a synchronous lighting and in example II there is an asynchronous lighting. In example III, the rhythm is effectively the same, but different photoperiods are applied. In examples IV, short daylengths for shrimps are selected, and a long photoperiod for photo-autotrophic organisms. In examples V, an example is depicted wherein over time the daylength of the arthropod lighting is increased.

Note that not only the on-off periods may be varied, but also the light intensity may be varied over time within the respective lighting periods. This may have further beneficial effects.

Further, a computer program product comprising instructions for execution on a computer functionally coupled to an arthropods and photo-autotrophic organism growing system 100 wherein the instructions, when executed by the computer, cause the arthropods and photo-autotrophic organism growing system 1000 to carry out the method according as defined herein is disclosed.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include examples with “entirely”, “completely”, “all”, etc. Hence, in examples the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes examples wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an example refer to “consisting of” but may in another example also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the examples described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further example” and similar terms may refer to an example comprising the features of the previously discussed example, but may also refer to an alternative example.

It should be noted that the above-mentioned examples illustrate rather than limit the invention, and that those skilled in the art will be able to design many alternative examples without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an example of the method is described being executed in a device, apparatus, or system, it will be understood that the device, apparatus, or system is suitable for or configured for (executing) the method or the example of the method, respectively.

The various aspects discussed in this patent can be combined in order to provide additional advantages. Further, the person skilled in the art will understand that examples can be combined, and that also more than two examples can be combined. Furthermore, some of the features can form the basis for one or more divisional applications.

1. A method for growing arthropods and photo-autotrophic organisms in a shared water recipient, wherein the method comprises:
monitoring an arthropod monitoring parameter of the arthropods in the shared water recipient, wherein the arthropod monitoring parameter is related to one or more of growth, metabolism, and behavior of the arthropods; and
controlling a photo-autotrophic organism control parameter of the photo-autotrophic organisms in the shared water recipient in dependence of the arthropod monitoring parameter, wherein the photo-autotrophic organism control parameter influences one or more of growth and metabolism of the photo-autotrophic organisms,
wherein controlling the photo-autotrophic organism control parameter comprises one of (i) selectively influencing the one or more of growth and metabolism of the photo-autotrophic organisms without essentially influencing the one or more of growth, metabolism and behavior of the arthropods, and (ii) promoting the one or more of growth and metabolism of the photo-autotrophic organisms while not promoting or while slowing down one or more of growth and metabolism of the arthropods.

2. The method according to claim 1, wherein the method comprises controlling an arthropod control parameter of the arthropods in dependence of the arthropod monitoring parameter, wherein the arthropod control parameter influences one or more of growth, metabolism and behavior of the arthropods.

3. The method according to claim 1, wherein the method comprises maintaining during at least part of a growth time an equilibrium between the growth of the arthropods and the growth of the photo-autotrophic organisms.

4. The method according to claim 1, wherein controlling the photo-autotrophic organism control parameter comprises promoting the one or more of growth and metabolism of the photo-autotrophic organisms with a first rate R1 and promoting the one or more of growth and metabolism of the arthropods with a second rate R2, wherein R2/R1≤0.75.

5. The method according to claim 1, wherein controlling the photo-autotrophic organism control parameter comprises promoting the one or more of growth and metabolism of the photo-autotrophic organisms by providing photo-autotrophic organism light having a first spectral power distribution and according to a first time-intensity scheme.

6. The method according to claim 1, wherein the photo-autotrophic organism control parameter is selected from the group of (i) an ammonium concentration and (ii) a nitrate concentration in water in the water recipient.

7. The method according to claim 1, wherein the arthropod monitoring parameter of the arthropods comprises one or more of (i) a feed conversion ratio of the arthropods, (ii) motility of the arthropods, (iii) size of the arthropods, (iv) reproduction of the arthropods, (v) excretion products of the arthropods, and (vi) molting of the arthropods.

8. The method according to claim 1, wherein the method comprises cultivating the arthropods according to a predefined growth scheme, and wherein the method comprises controlling the photo-autotrophic organism control parameter of the photo-autotrophic organism in the shared water recipient in dependence of the predefined growth scheme of the arthropods.

9. The method according to claim 2, wherein controlling the arthropod control parameter comprises promoting the one or more of growth and metabolism of the arthropods by providing arthropod light having a second spectral power distribution and according to a second time-intensity scheme; wherein the second spectral power distribution comprises at least 80% of the spectral power in the wavelength range of 400-800 nm within the wavelength range of 480-620 nm, and wherein the first spectral power distribution of photo-autotrophic organism light comprises at least 20% of the spectral power in the wavelength range of 400-800 nm within the wavelength range of 620-700 nm and less than 30% of the spectral power in the 480-620 nm wavelength range.

10. The method according to claim 1, wherein the arthropod comprises a species selected from the group comprising Crustacea and wherein the photo-autotrophic organisms comprise algae.

11. A non-transitory computer readable medium comprising instructions for execution on a computer functionally coupled to an arthropods and photo-autotrophic organism growing system wherein the instructions, when executed by the computer, cause the arthropods and photo-autotrophic organism growing system to carry out the method according to claim 1.

12. An arthropods and photo-autotrophic organism growing system comprising (i) a water recipient for hosting a liquid with the arthropods and photo-autotrophic organism, (ii) one or more sensors for monitoring an arthropod monitoring parameter or, (iii) one or more controlling devices for controlling a photo-autotrophic organism control parameter and/or an arthropod control parameter, and (iv) a control system, wherein the control system is configured to:
monitor the arthropod monitoring parameter of the arthropods in the shared water recipient, wherein the arthropod monitoring parameter is related to one or more of growth, metabolism, and behavior of the arthropods; and
control the photo-autotrophic organism control parameter of the photo-autotrophic organisms in the shared water recipient in dependence of the arthropod monitoring parameter, wherein the photo-autotrophic organism control parameter influences one or more of growth and metabolism of the photo-autotrophic organisms,
wherein controlling the photo-autotrophic organism control parameter comprises one of (i) selectively influencing the one or more of growth and metabolism of the photo-autotrophic organisms without essentially influencing the one or more of growth, metabolism and behavior of the arthropods, and (ii) promoting the one or more of growth and metabolism of the photo-autotrophic organisms while not promoting or while slowing down one or more of growth and metabolism of the arthropods, and in dependence of a sensor signal of the one or more sensor and with the one or more controlling devices.

13. The arthropods and photo-autotrophic organism growing system according to claim 12, wherein the one or more of the controlling device comprises a light generating system configured to generate system light, wherein the system light has a controllable spectral power distribution; wherein in an operational mode of the light generating system the system light comprises photo-autotrophic organism light having a first spectral power distribution and the system light is provided according to a first time-intensity scheme.

14. The arthropods and photo-autotrophic organism growing system according to claim 13, wherein in an operational mode of the light generating system the system light comprises arthropod light having a second spectral power distribution and the system light is provided according to a second time-intensity scheme; and
wherein the first spectral power distribution of photo-autotrophic organism light comprises at least 20% of the spectral power in the wavelength range of 400-800 nm within the wavelength range of 620-700 nm and less than 30% of the spectral power in the 480-620 nm wavelength range, and wherein the second spectral power distribution comprises at least 80% of the spectral power in the wavelength range of 400-800 nm within the wavelength range of 480-620 nm.

15. The arthropods and photo-autotrophic organism growing system according to claim 12, where the one or more sensors for monitoring an arthropod monitoring parameter comprise one of a behavioral sensor, a biometric sensor and an environmental sensor.
